(19) United States
(12) Patent Application Publication
(10) Pub. No.: US 2005/0193330 A1
(43) Pub. Date: Sep. 1, 2005

(54) Methods and systems for eBook storage and presentation

(75) Inventor: Keith Peters, Somerville, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Exit 33 Education, Inc., Boston, MA (US)

(21) Appl. No.: 11/068,408

(22) Filed: Feb. 28, 2005

Related U.S. Application Data
(60) Provisional application No. 60/548,724, filed on Feb. 27, 2004.

(51) Int. Cl. G06F 17/24; G06F 17/21

(52) U.S. Cl. 715/513

(57) ABSTRACT

The methods and systems described herein can efficiently store electronic documents as a plurality of files, and can provide an interface for presenting electronic documents for viewing. Each page of the document can be stored as a separate Flash file. The interface or reader can itself be a Flash file that presents tools for choosing pages to be displayed. The interface can display the Flash file corresponding to the chosen page.

### RELATED APPLICATIONS

This application claims priority to, and incorporates by reference, the entire disclosure of U.S. Provisional Patent Application No. 60/548,724, filed on Feb. 27, 2004.

### FIELD

The methods and systems relate to storing and reading electronic documents, or eBooks.

### BACKGROUND

Access to information in a variety of media has improved with advances in computer technology, providing consumers with convenient and economical ways to obtain such information. In particular, the development of electronic documents and books, or eBooks, has facilitated computer-based learning, publishing, and other forms of web-based information access. An electronic book reader is a virtual device that receives documents, publications, or reading materials downloaded from an information network. Users of an electronic book can read downloaded contents of documents, publications, or reading materials that may, for instance, be received from a participating bookstore, or as part of course content in a learning environment. The user can read or view the documents at his or her own convenience without the need to purchase a printed version.

Much like ordinary printed books or documents, eBooks can be used to present text and pictures to readers. The eBook is essentially a collection of digital data that software, known as an electronic book reader, can interpret and present to the reader on a display. A variety of devices run electronic book reader software such as personal computers, handheld personal digital assistants (PDAs), cellular phones with displays, and so forth. EBooks offer a variety of features not traditionally associated with print books. For example, instead of only text and pictures, an eBook may also store data used to present sound such as music and speech. Further, instead of only still pictures, an eBook can also present animated images. Additionally, eBooks can be delivered to remote locations almost instantaneously by transmitting the data for the eBooks over a computer network.

### SUMMARY

I have recognized, though, that eBooks as currently configured suffer from drawbacks and can present problems to a user or reader. Some problems can result from the fact that the collections of digital data that make up eBooks are conventionally stored as a single large file. Even if only a portion of the eBook is to be viewed, the complete book must be obtained. Downloading pages of the eBook for viewing or reading can be a lengthy process. The pages are generally downloaded sequentially. When a user wants to skip reading some pages, or wants to start reading at other than the first page, the user must wait for each intermediate page, or the beginning pages to download.

The methods and systems described herein efficiently store electronic documents as a plurality of files, and provide an interface for presenting electronic documents for viewing. Each page of the document is stored as a separate Flash file. The interface or reader can itself be a Flash file that presents tools for choosing pages to be displayed. The interface displays the Flash file corresponding to the chosen page.

In one embodiment, a method of presenting content pages of a document includes storing the document as a plurality of flash files, each flash file including a different content page of the document for presentation, providing a flash reader file including tools for choosing content pages and displaying flash files, receiving input to the flash reader file indicating a chosen content page from the document, and executing the flash reader file to display a flash file corresponding to the chosen content page to present the chosen content page.

In some aspects, storing the document can include identifying content pages in the document to obtain identified content pages, translating each of the identified content pages as a flash file for storage as one of the plurality of flash files, creating a manifest of the plurality of flash files, and identifying in the manifest each of the flash files as a being a part of the document, an order of the plurality of flash files corresponding to an order of the content pages in the document, and a storage location for each of the plurality of flash files. Creating the manifest includes generating an XML file, where the flash reader file reads the XML file to determine the flash file corresponding to the chosen content page for display, and translating includes generating a key in each of the flash files to prevent displaying the flash file without executing the flash reader file. The can include password protection, and executing the flash reader file includes receiving login information, and authorizing execution of the flash file reader based on the login information.

In some aspects, translating includes embedding, in each of the flash files, processing information including processing dates and/or processing times, and embedding document information including a document name, author name, chapter name, chapter number, section name and/or copyright information. When the document is formatted as an XML file, content pages may be identified by defining an amount of content for a flash file, so that each identified page contains no more than the amount of content defined. When the document is formatted as a PDF file, content pages may correspond with the page breaks of the PDF file.

In one embodiment, an interface for reading an electronically stored document is stored on computer-readable medium as a plurality of flash files with each flash file corresponding to a content page of the document, and includes instructions for controlling a processor to display a flash movie, the movie including tools for choosing content pages of the document and displaying flash files, receive input through the tools indicating a chosen content page from the document, and display a flash file corresponding to the chosen content page for reading of the chosen content page.

The instructions for controlling the processor to receive input include instructions to highlight portions of the chosen content page to provide a highlighted portion for differentiating the highlighted portion from other portions of the display, and associate highlighting information for the highlighted portion with the flash file corresponding to the chosen content page. The interface can include instructions to delete the highlighted portion, add a link from the highlighted portion to another portion of the chosen content page and/or another of the content pages, associate a media file with the highlighted portion, display at least one media file associated with the highlighted portion, associate a URL with the highlighted portion, open a browser window and load a web page corresponding to a URL associated with the highlighted portion, and attach a note to the highlighted portion. The highlighting information may be stored on a local processor executing the instructions for the interface and/or a server connected to the local processor, where the server transmits the flash files to the local processor for display.

The interface may include displaying a text input field on the chosen content page, receiving text input into the text input field, and display the text input in a note field on the chosen content page when the chosen content page is displayed. The note field data can be stored on computer-readable medium at a local processor executing the instructions for the interface and/or a server connected to the local processor, where the server transmits the flash files to the local processor for display. The note field can be associated with the chosen content page, wherein the note field is displayed only on the chosen content page, and/or the note field can be associated with the document, wherein the note field is displayed on each content page chosen.

The interface can display a listing of tab functions, with the listing including a search function, a bookmark function and tab functions for displaying a table of contents for the document, a glossary for the document and an index for the document. The interface can receive input indicating a chosen tab function, and can execute the chosen tab function. Executing the search function includes receiving text input, in response to the text input, displaying a listing of instances of the text input in the document, the listing including, for each instance, text adjacent to the text input, receiving input indicating a chosen instance, and in response to the input indicating a chosen instance, display a flash file corresponding to a content page having the chosen instance thereon, where the chosen instance is differentially displayed from other portions of the content page.

Executing the bookmark function includes displaying a listing of bookmarks, displaying text associated with a bookmark when an indicator is located on the bookmark, in response to input indicating a chosen bookmark, displaying a flash file corresponding to a content page associated with the chosen bookmark, and in response to input indicating adding a new bookmark, displaying a text input field, receiving text input into the text input field, associating the text with the new bookmark, and adding the new bookmark to the listing of bookmarks.

Displaying the table of contents includes displaying the table of contents for the document, and in response to input indicating an item in the table of contents, displaying a flash file corresponding to a content page associated with the item. Displaying the glossary includes displaying the glossary for the document, and in response to input indicating a term in the glossary, displaying a definition of the term. Displaying the index includes displaying the index for the document, the index including hierarchical listings of terms and corresponding indications of content pages associated with each of the terms, and in response to input denoting an indication, displaying a flash file corresponding to a content page associated with the term that the indication corresponds with.

The interface can link to a file containing an activity associated with the chosen content page, display the activity, and store results of the activity in response to input denoting completion of the activity. Linking to a file containing the activity includes, prior to linking, displaying a notice that an activity is associated with the chosen content page, and receiving input denoting acceptance of the activity.

In one embodiment, a method of converting an electronic document includes identifying content pages in the document to obtain identified content pages, translating each of the identified content pages as a flash file for storage as one of a plurality of flash files, creating a manifest of the plurality of flash files, identifying in the manifest each of the plurality of flash files as a being a part of the document, an order of the plurality of flash files corresponding to an order of the content pages in the document, and identifying in the manifest a storage location for each of the plurality of flash files.

### BRIEF DESCRIPTION OF THE DRAWINGS

The following figures depict certain illustrative embodiments in which like reference numerals refer to like elements. These depicted embodiments are to be understood as illustrative and not as limiting in any way.

FIG. 1 is a schematic representation of components of the eBook storage and presentation system;

FIGS. 2A and 2B show a schematic flow chart of electronic document conversion;

FIG. 3 is an illustrative screen shot of an interface for reading a converted electronic document; and

FIG. 4 is an illustrative screen shot of an interface displaying a page of the document with an associated activity.

### DETAILED DESCRIPTION OF CERTAIN ILLUSTRATED EMBODIMENTS

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, interchanged, and/or rearranged without departing from the disclosed systems or methods. Additionally, the shapes and sizes of components are also exemplary and unless otherwise specified, can be altered without affecting the disclosed systems or methods.

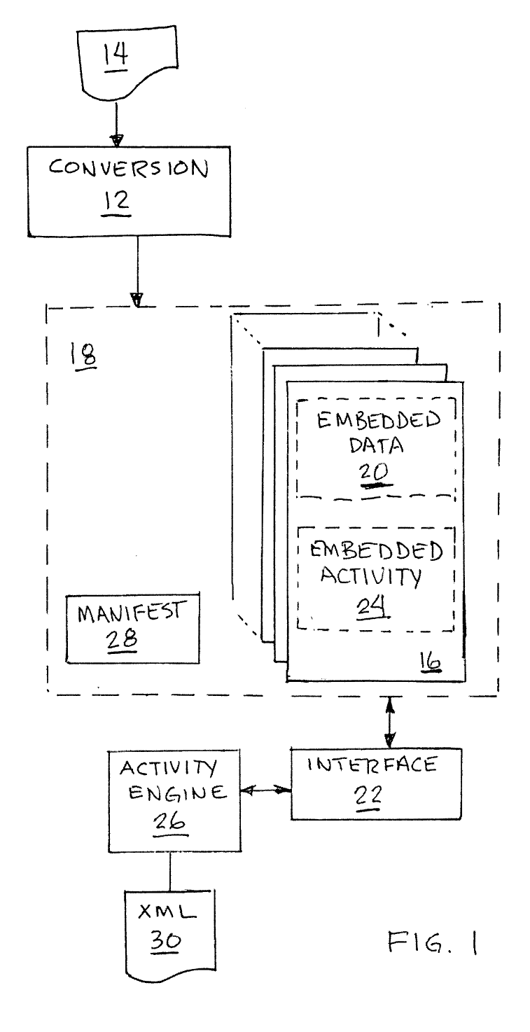

Referring to FIG. 1, the disclosed methods and systems relate to features of a Flash-based media book platform that includes four main applications or modules: the conversion module 12, eBook 18, interface 22, and activity engine 26. Conversion module 12 converts an electronic document file 14, e.g., a Quark, portable document format (PDF), extensible mark-up language (XML), or other format file, into a plurality of ShockWave Flash (SWF) movies, or .SWF files 16 that, typically together with other-format files, constitute eBook 18. Each Flash movie or file 16 includes one page of the original electronic document 14. In the identified embodiment, each Flash file 16 also includes embedded data or information 20 that identifies the book, chapter, author and/or other relevant information about the electronic document 14 to which it belongs. Greenbook interface 22 presents the eBook 18 to a user. The interface 22 can itself be a Flash movie. The interface movie 22 loads in and displays the individual pages or Flash files 16. Using the interface 22, a user can read an eBook 18, make notes, highlights, bookmarks, and participate in activities 24 embedded in the Flash files 16.

A given eBook may include “activity” content such as buttons and other objects with which the user can interact to elicit effects such as animation, sound, etc. FIG. 1 includes a separate activity-engine block 26 to represent the fact that the illustrated embodiment is configured to present the book's activity content and that the programming for activity presentation is not necessarily contained in the same file or files as the rest of the interface programming. Moreover, although the activity engine is depicted as separate from the eBook 18, it can instead take the form of, for example, a single Flash component embedded in a page-containing SWF file. For the sake of concreteness, though, we will assume that the activity engine in the illustrated embodiment is separate from the eBook but that the activities that it displays for a given page are specified by, say, an XML file 30 that a manifest file 28 included in the book identifies.

Of course, this is but one of the ways in which a Flash-based eBook can provide activities. For example, a page-containing SWF file 16 may contain directions to load the necessary programming—and possibly needed data—from local storage or some Web location. When the reader arrives at a page that includes an activity, it displays a notice indicating that there is an activity associated with the material on the page. When the user acknowledges the notice by, e.g., clicking on the notice or selecting an icon, interface 22 loads programming and/or data in accordance with those directions and causes that programming to be executed.

One way of converting a PDF file into single-page SWF and related files uses a conventional Flash integrated development environment (“IDE”). By invoking the IDE's import-PDF feature, the user causes the IDE to produce from an identified PDF file a Flash source (FLA) file. If compiled, that file's contents would produce a Flash object (SWF) file that a Flash could play to display what the PDF player reader would have displayed if the PDF file had been submitted to it. Conventionally, the FLA file would contain respective “frames” for each page of the PDF file's contents.

According to the present invention, different pages or subsets of them are to reside in different SWF files, and one way to do that is first to divide the FLA file into multiple FLA files, each of which contains a different one of the original FLA file's frames. This operation can be automated by, for example, employing the IDE to execute a Java Script Flash (JSFL) script that directs it to create separate the separate FLA files and draw their contents from respective frames. For reasons that will become apparent, each resultant (individual-frame) FLA file is revised to group the objects that it contains into an object that is then set to be invisible. Typically, some sizing will also be done, and a visible background may be added to provide something to display while the original content is invisible. Also, separate invisible content may be included to, for example, identify the particular book to which the constituent FLA file belongs. Also, programming may be provided that can be invoked to switch the main invisible group back to visible only if the operator of the Flash reader to which the resultant object code is submitted provides the right password.

The IDE can execute further JSFL script to compile the several FLA files into SWF files and to generate manifest 28, which the interface program will use to summon the appropriate files in response to user input requesting respective pages. As will be explained below, more-manual operations may also be performed to make various corrections and generate searchable files that give indexes, glossaries, etc., that the reader application can use.

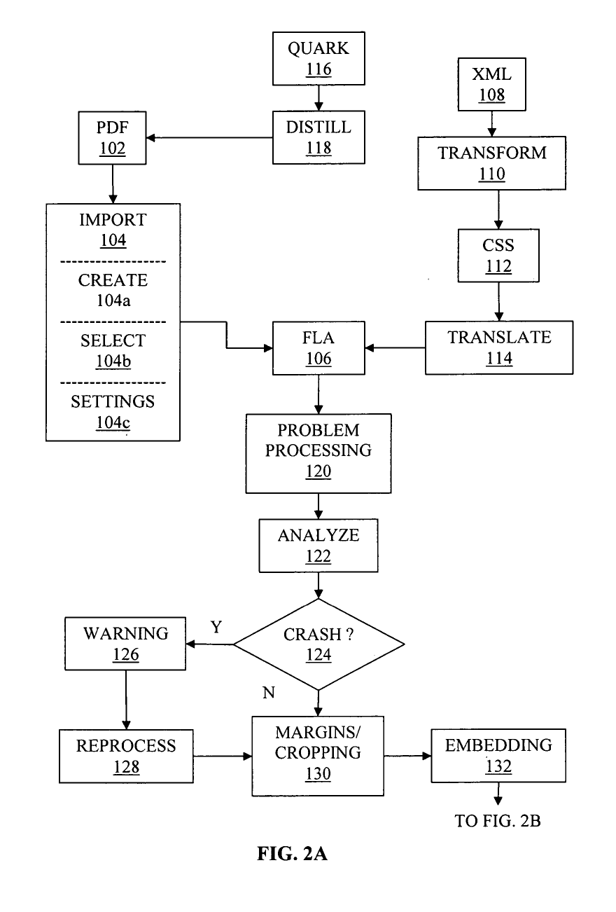

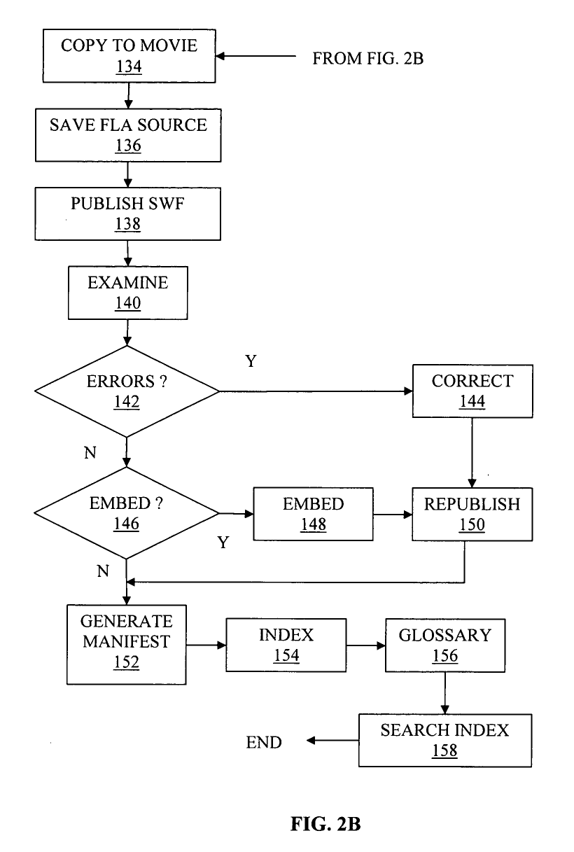

FIGS. 2A and 2B illustrate in more detail an operation 100 for performing such conversions and others. Different conversion techniques can be used depending on the file format of the electronic document. For a PDF document 102, JSFL code is executed to import 104 the PDF file into a Flash movie document, or FLA file, as is known in the art. The importation of the PDF document includes choosing to create a new Flash movie 104a, selecting the “File→Import→Import to Stage” command 104b and selecting the PDF file for importation 104c using the settings:
Convert pages to: Scenes,
Convert layers to: Flatten
Which pages to import: All, and
Options: Only check ‘Maintain text blocks’.
   Importing the PDF document creates the FLA files 106 containing respective frames for each page of the PDF files' contents.

For an XML document 108, an extensible style sheet language transformation (XSLT) is performed 110 such that the document can be presented in a consistent manner across a variety of web browsers. Cascading style sheets (CSS) are applied 112 to provide specific fonts, colors, spacings, etc. The resulting file is translated 114 into a Flash movie document, to create the FLA file 106, with each page converted to a frame. Particularly in the case of XML files, pages may not be identified as such, so appropriate-sized files may be made by so providing page breaks that each page contains approximately a predefined amount of content. It can be understood that electronic documents having other file formats can be similarly converted by identifying pages within the document and deriving an SWF file for each page. In some instances, e.g., when the electronic document is a Quark file 116, the electronic document is first distilled 118 to a PDF document before beginning conversion process 100 at 102.

The FLA file is further processed to identify and correct 120 problems that may cause improper display of the movie, e.g., characters that do not display correctly, incompatible fonts, and/or hidden visual elements caused by the structure of the imported elements. In one exemplary embodiment, a custom script is written for the IDE to process the FLA file and correct each instance of the specific problem it finds. Where more than one file makes up the electronic document, e.g., a book consisting of a PDF document for each chapter of the book, this script can be run on each subsequent document/chapter to ensure all such problems are handled throughout the book. Other methods for correction of such problems generally known to those skilled in Flash IDE programming can be contemplated.

The Flash movie is analyzed 122 to calculate the number of text fields, bitmap pictures and vector shapes on each page. If a bitmap is found 124 to be large enough to potentially crash the conversion process, a warning is given 126, and the bitmap removed or reprocessed 128 to be a more manageable size prior to conversion. Page margins and cropping are then specified 130 and information to be embedded into the pages of the book is entered 132, including author name, book name, chapter name and number and copyright information.

The embedded information can include a security code inserted on one or more of the pages to prevent those pages from being viewed by other than a Flash reader having a key for interpreting the code, such as interface movie 22 would have. The code/key information can include known password, public/private key protection schemes, and other secured access schemes known in the art. Such a scheme can be used to restrict access not only to the book as a whole but also to individual portions. For example, a course of instruction can require students to read a certain assigned page or range of pages from a document. Through appropriate use of the code, passwords, etc., only the assigned pages are available to the student.

Once processing 120, analysis 122, margins and cropping 130, and embedding 132 are completed, elements of each page are copied 134 to a new movie, for which the FLA source is saved 136 and the SWF page is published 138. As used herein, publishing the SWF page includes compiling the FLA source code to obtain the virtual-machine code used by interface 22 to display the document page.

Although certain of the just-described operations may be performed manually, it is preferable for as many as practical to be performed in the IDE under the direction of a JSFL script. In most embodiments, though, the SWF pages are ultimately examined 140 by a human operator to determine whether the conversion has taken place correctly; e.g., fonts and locations of elements can be examined. The examination compares the SWF pages to the original text of the document or to the original electronic document and corrects problems encountered. If major and/or consistent errors are found 142, custom script can be used to correct the errors 144 for each page, in the manner similar to that described for correcting problems at 120. If so chosen (146), activities in the form of pre-built custom Flash components, or custom audio, video or other media are embedded 148 in the page. If corrections were done to an SWF page, and/or activities or media were added, as at 148, the page is republished 150.

As was explained above, a (typically XML-format) manifest 28 is generated 152, which specifies the name and location of each page SWF. Manifest 28 can be generated manually, or it can be generated automatically by, for example, reading the directory where the SWF files are located. An exemplary format of the XML file or manifest 28 follows, though other formats and/or additional information for the manifest can be contemplated by those of skill in the art:

```
<book title=“Book Title” author=“Author Name”>
    <page num=“1” file=“book_name_chapter01_page01.swf” />
    <page num=“2” file=“book_name_chapter01_page02.swf” />
    <page num=“3” file=“book_name_chapter01_page03.swf” />
    ...etc.
</book>
```

Optionally, XML files can be generated for the index 154 and glossary 156, in addition to the manifest. Exemplary formats for the index and glossary follow, although other formats and/or additional information for the index and/or glossary can be employed instead:

for the index:

```
<index title=“Book Title” author=“Author Name”>
    <term pages=“1,23,45”>dog</term>
    <term pages=“56,67,89”>cat</term>
    <term pages=“101,202,303”>mouse</term>
    ... etc.
</index>
```

and for the glossary:

```
<glossary title=“Book Title” author=“Author Name”>
    <term pages=“1,23,45” definition=“an animal”>dog</term>
    <term pages=“56,67,89” definition=“an animal”>cat</term>
    <term pages=“10,202,303” definition=“an animal”>mouse</term>
    ... etc.
</glossary>
```

To create the search index, as at 158, known IDE tools can be used. The name of the directory where the original FLA files for each chapter are stored are provided. The script then goes through each FLA and indexes each text field found, including each field's page and vertical position on the page. This data is saved to a text file, which is available to interface 22. A script file having knowledge of the format of this text file uses it to quickly locate any term in the book, what page it is on, and the position on the page. The locations of the SWF page files, XML files and text files are provided to interface 22 when the book is to be read. Alternately, the locations can be coded into interface 22. In this embodiment, interface 22 is used only for those books having the file locations coded therein.

In preparing the SWF movies for each page, conversion process 100 formats the Flash movie to provide a custom look to the document as it is being viewed. The Flash movie is sized to fit the contents of the document page and a background is created for each page. The information embedded with each page, e.g., document name, author, etc., can be displayed thereon. Font outlines are embedded for each piece of text so that each user can see the proper font regardless of whether they have that font installed on their local processor.

As is known in the use of other character recognition software tools, where the original document includes static text, e.g., unsearchable text, conversion process 100 converts the static text to dynamic text, to allow for text searching and glossary functions. The dynamic text can be altered at run time, allowing for highlighting of found terms in the text. As is known in the art, SWF movies can provide text in a vector format. Thus, pages can be zoomed in or out at the viewer's discretion, while retaining full crispness of text outlines, as well as maintaining sharpness of vector graphics contained in the page.

The use of SWF files for each page of the document provides a number of advantages. The size of the SWF files ranges from a few kilobytes to a few hundred kilobytes, depending generally on the size and number of graphics contained in the page. The relatively small size of the SWF files, when compared to the full original document, allows for quicker downloading of each individual page. Also, viewing of the document need not start at the first page. Rather the viewer or user can choose the page to view first. For example, if a user chooses to first go to page 200, interface 22 immediately loads that page, rather than having the user wait while pages 1-199 are loaded, as would be the case for a single file having all or multiple pages of the document.

In one embodiment, interface 22 preloads pages following the page currently being viewed. For instance, in the example above, when the viewer went to page 200, interface 22 loads pages 201, 202, etc. Thus, interface 22 makes the page the viewer would most logically go to next available without a wait. Such preloading can be used in conjunction with searching, indexing and using the glossary. Generally, the term being requested may be located on multiple pages. Interface 22 displays the first page identified and preloads further pages containing the term.

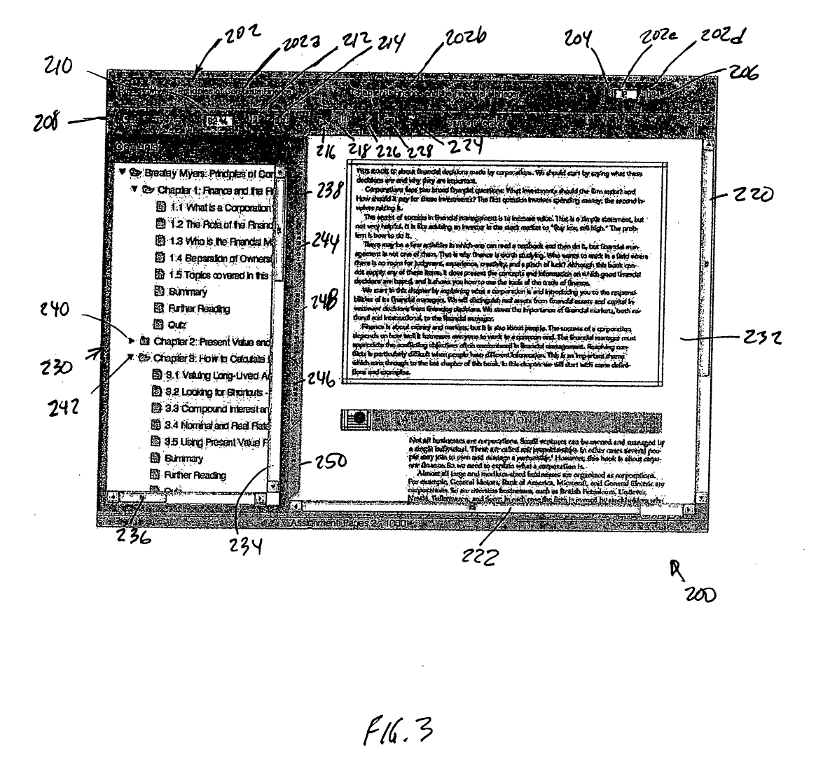

Referring now to FIG. 3, there is shown an illustrative screen shot 200 of interface 22. Using interface 22, a user reads documents or books, make notes, highlights, bookmarks, and participates in activities that can be embedded in the pages of documents or books, as further described in more detail herein. As noted, interface 22 is a Flash movie that loads and displays the individual pages of the document (SWF movies) generated by conversion module 12, as previously described with relation to process 100 of FIG. 2.

In one embodiment, interface 22 is delivered to a user as an object in a web page. Alternately, interface 22 is delivered as a standalone executable program that runs directly on a user's computer. In this embodiment, the pages or SWF files are also delivered as a package and stored locally. This can provide for packaging a complete document or book and the reader used to display the document on computer-readable medium, such as a CD. Combinations of web delivery and standalone programs can be contemplated. For example, interface 22 can be delivered as a standalone program and the documents can be delivered through an internet or other network connection. In one embodiment, interface 22 is set to load a specific book, either by hard coding it into the Flash movie for the interface itself or by passing the data to the Flash movie via HTML. Alternately, interface 22 contains a book choosing menu or dialog, allowing a user to choose among multiple books available to him.

While specific functions of interface 22 can be customized for displaying the individual SWF movies, it can be understood that generating the Flash movie for interface 22 includes the use of methods and programming tools known to those of skill in the art of creating such Flash movies. Customization includes providing a fixed format for interface 22, e.g., 800×600, with fixed graphics, fonts and colors. Alternately, the user can choose from among a number of formats, colors, etc., and/or the display scales as the size of the browser window changes. While FIG. 3 illustrates one specific interface, interface 22 is not so limited. Other changes in formatting, colors, backgrounds, locations of items, etc. can be contemplated.

As previously described, each page or SWF movie include embedded information regarding the document from which it was converted. Interface 22 reads the embedded information for the page being viewed and displays the information in an identification bar or panel 202. In the illustrative interface of FIG. 3, identification panel 202 includes document name, (202a) chapter number and title (202b), the page number being viewed (box 202c) and the total number of pages (202d). The user can activate forward and back buttons (204, 206), such as by a mouse click, to view the next or previous page. By entering a specific page number in box 202c, the user proceeds directly to that page.

Interface 22 includes a slider 208 for zooming the page view in or out. A numeric value for the zoom can be entered in zoom box 210. Preferably, the numeric values range from about 25% to about 600%, though interface 22 can be customized to include other values and/or ranges. Slider 208 snaps to preset values, e.g., 75%, 100%, 125%, etc. when it is moved close to one of those values. Optionally or additionally, buttons 212, 214 can be provided that allow the page to be fitted to the full width of the window or the full height of the window when so chosen by the user, as by clicking with a mouse.

Interface 22 illustrates a number of tools for choosing a mode of interacting with the view. Arrow 216 provides a tool for deleting and/or editing highlights and interacting with activities on the page and for disabling the other modes. Hand tool 218 allows for dragging or moving the page around the window to a particular position. Scroll bars 220, 222 on the side and bottom of the window also provide for moving the page in the display. Print tool 224 provides for printing a specific page or range of pages, or printing of notes. Printing can be disabled or otherwise not available on interface 22 for one or more pages, chapters, or for the whole document if a client preparing the document for viewing so chooses.

Highlighter tool 226 the user to highlight text or graphics on an individual page. In one embodiment, when highlighter tool 226 is activated, such as by clicking with a mouse, a drop-down menu appears, which offers a choice of colors of highlighters (e.g., yellow, pink, green). Once a color is chosen, interface 22 enters the highlight mode. The user can now draw on the page in a transparent color, duplicating the functionality of a real highlighter. The drawing can be done in a freeform mode, or optionally, the user can choose, through a control key, menu choice, or other known designating means, to have the highlighting drawn as a straight, horizontal line, or as rectangular areas of text. The highlights are embedded in the page and thus scale up and down with the page, retaining their relative position, size and shape, as the page is zoomed in or out. Highlighting can be deleted by switching to arrow tool 216 and selecting the highlighting, such as by a mouse click on the highlighting. For ease of description, the use of a mouse click will be used to indicate various actions, such as designating, activating, choosing, selecting and/or otherwise initiating an action.

In addition to the above highlighting, the drop-down menu appearing when highlighting tool 226 is activated provides an option for a link highlight, which has a separate color designation from the other highlighting. The link highlight option can be provided to users having editing rights to the document display. For example, a course instructor can have such rights, while students can have very limited editing rights or can have no editing rights. Once a link highlight is drawn, clicking on the link highlight with arrow tool 216 opens a dialog box that allows a number of different options for the user with rights, including deleting the highlight, adding a note to the highlight, adding a page link to the highlight, adding a URL to the highlight, and, for existing link highlights, going to the link or URL in the link highlight and editing the highlight.

When a note is added to the link highlight, thereafter moving the cursor over the link highlight displays the note. Adding a link provides a link to a particular page in the same document or book, or to another Flash movie, or to other media. When a link highlight with a page link is clicked on, interface 22 goes to the particular page or Flash movie indicated in the link highlight. A URL to an external web page can be added to the link highlight. When such a link highlight is clicked on, a new browser window opens and loads the referenced web page.

Note tool 228 provides for adding a note to a page. When note tool 228 is clicked on, a new note appears in the center of the page being viewed, having a designation, e.g., a color or outline, as chosen by the user. The note can be dragged to any position on the page. The user can type a title for the note along with an amount of text. To save screen space, the note can be minimized so only its title is displayed. Notes created by note tool 228 are generally page specific, such that the user will only see notes created on that page. Optionally, the note can be designated as a global note that can be seen on every page. Preferably, the position and size of the note remains the same while zooming a page, so as to remain readable. The notes are closed and/or deleted by clicking on the appropriate button on the note. A deletion confirmation box is provided. When a page is called up for viewing, notes previously closed are displayed again. As with link highlights, notes input by a user having editing rights can be unalterable and/or not delete-able by a user without editing rights.

For the embodiment illustrated in FIG. 3, interface 22 includes a number of tabs along one edge of the display. Clicking on one of the tabs opens up a panel that gives access to a number of other functions. For the exemplary interface of FIG. 3, the tabs and panel are shown to the left of the page being viewed, though other locations, including having the tabs displayed as a floating reference panel, can be contemplated. When the side panel 230 is open, the window 232 that shows the page moves to the right and is made smaller to fit the remaining space. Alternately, the user can choose to have content window 232 retain its full size, with side panel 230 open on top of it. Side panel 230 includes scroll bars 234, 236 used to move the contents of side panel 230 for viewing.

The tabs include a Table of Contents (TOC) tab 238. When TOC tab 238 is clicked on, as is illustrated in FIG. 3, side panel 230 shows the structure of the document, listing the chapters and pages the chapters begin on. The TOC is obtained from the manifest created when the document is converted. The TOC also includes sections and sub-sections, depending on the classifications in the manifest. The TOC also lists embedded activities under the pages that they appear on. The TOC can be expanded or contracted using the respective icons 240, 242 adjacent to the listing, as is known in the art. When a listing is clicked on, interface 22 goes to the page associated with the listing.

Search tab 244 allows a user to enter a word, part of a word, multiple words or a Boolean expression for performing a case-sensitive or case-insensitive search using the search index previously described. When a search is performed, a listing of instances of the search term found in the book is displayed. In one embodiment, the line of text containing the search term is displayed to provide a context for the term. When one of the results in the listing is chosen, interface 22 goes to the associated page, and highlights or otherwise differentiates the specific instance(s) of the term from the other text on the page.

Glossary tab 246 provides a listing of key words or terms in the text using the glossary previously described. Clicking on a term displays its definition. A search window is provided in the Glossary panel that implements the search function, as described for search tab 244, thus enabling the user to find specific instances of the key term in the text.

Bookmark tab 248 provides a listing of bookmarks and the bookmark panel includes a text field for the user to enter a note regarding the current page, which can be added to the bookmark listing by clicking an icon in the bookmark panel. When one of the bookmarks in the listing is chosen, interface 22 goes to the associated page.

Index tab 250 provides a hierarchical listing of terms in the document using the index previously described. The listing can be similar to the TOC listing, in that the listing can be expanded or contracted, to show varying hierarchical levels. For example, the index term “animals” may have sub-terms “dogs”, “cats”, “mice”, etc. and the sub-term “dogs” may have further sub-terms “poodles”, “terriers”, “retrievers”, etc. Each term has a page or multiple pages associated with it. When a term is clicked on, interface 22 goes to the associated page.

In one embodiment, the functions described for interface 22 are modular, in that they can be added to or removed from a specific instance of interface 22. Thus, if a particular function is not needed, such as highlighting or notes, the function can be removed from interface 22 before compiling it. If a function is to be added, the component is placed into interface 22 and it is recompiled. New features or functionalities to be added to interface 22 utilize the same kind of modularity, so that they may be easily added to an existing interface. Similarly, upgrades to features or functionalities are easily accomplished by removing the old component and adding the new.

As described previously, interface 22 is delivered to a user as an object in a web page, or as a standalone executable program. Similarly, data used in the methods and systems described herein is stored both on a server and locally. Different levels and combinations of data storage and connectivity can be chosen for a particular project. For example, in a standalone interface provided with the SWF files on a CD, highlighting, notes, bookmarking and other interactive functions can be disabled such that no data need be saved and no connection to a server is required. Alternately, the-standalone interface can include one or more interactive functions and the resultant data can be saved/stored on the local processor, again without connecting to a server.

In a further example illustrating a web delivered interface, the user logs in to the server, providing the key or authentication to obtain the interface and view the SWF movies. The interface is delivered via a web page and the HTML of the page specifies that the interface load a particular book and start on a particular page. When the interface is started, the interface loads the specified pages and displays the first page.

In one embodiment, data for highlighting, notes, bookmarks, activities, etc., is stored locally on the user's computer. For example, if the user creates a highlight, the color, position and shape of the highlight is saved to the user's hard drive. Similarly, a note is saved along with its color, position, title, body text and whether it is minimized or not. The text and page of each bookmark is also saved. Saving of the data is performed automatically when an element is created or changed (e.g., if a note is dragged to a new position, the new position is saved when the dragging is complete). Deleting a note, highlight or bookmark results in deleting the data describing it from the user's processor. When the interface is closed and then re-opened at a later time, the data for the notes, highlights, bookmarks, etc. is reloaded from the saved data. Again, the user need not explicitly load the data, activation of the interface reloads the data automatically.

However, the data would not be available if the interface were opened from another processor, such as a notebook, that did not have access to the hard drive where the data was stored. To provide for this case, in one embodiment, the data is also be sent to the server that delivers the document, and is stored in a database under the user's account. When the user creates or edits one of the saved elements, the data is saved to both the user's computer and the server. When the user logs in from any location to access the interface and document, a copy of the users' saved data is automatically downloaded.

In situations where a user obtains the interface and SWF movies from the server and goes off line to read it, or loses connection to the server while viewing the document, the data is saved to the hard drive, but no connection is available for saving the data to the server. When the interface is next opened from the server, both the locally stored data and the data stored on the server is updated as needed to include the latest editing data for each element.

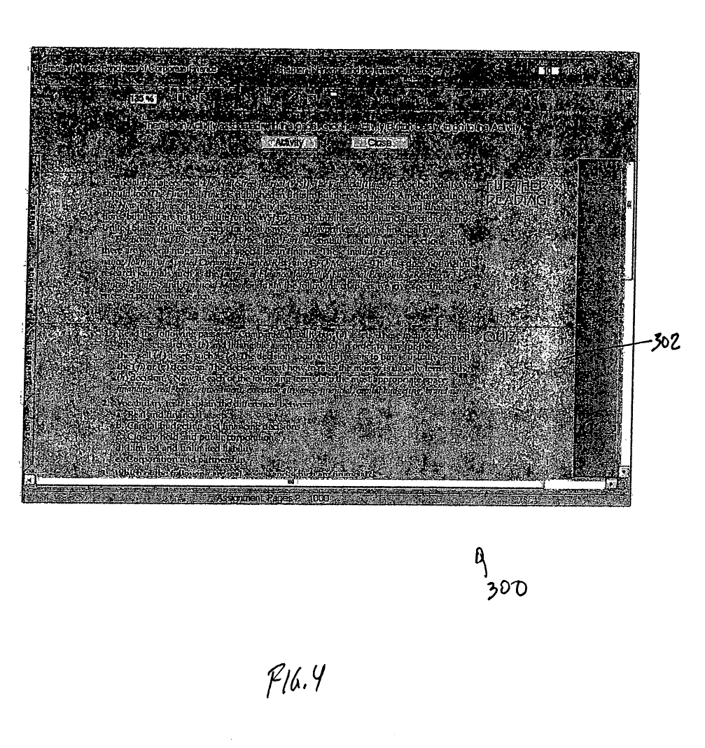

Referring now to FIG. 4, there is shown an illustrative screen shot 300 of interface 22 displaying a page with an activity 302. In one embodiment, activities include Flash components embedded in the document pages or externally linked to. Activities are developed using activity engine 26. Activity engine 26 includes a single Flash component that is put inside a Flash movie or embedded in an HTML page. Activity 302 can be sized, positioned and styled using known Flash programming tools. If embedded in a page, activity 302 includes a URL of an XML file that contains the description of that specific activity. As a Flash component, activity 302 reads in the XML and configures itself to display the activity.

Alternately, activities can live outside the pages in a separate HTML page. In this embodiment, interface 22 receives the URL of an activity XML file when interface 22 starts up. The activity XML file contains a list of the pages that contain one or more activities, and the URL of the individual XML file that describes the respective activity. When the user arrives at a page with an associated activity, a notice appears, based on the activity XML file, to so inform the user. When the user acknowledges the notice, e.g., by clicking OK, interface 22 calls the URL provided in the activity XML file and loads the XML file for that activity. The XML file for the activity opens a page containing the activity, as described above.

Activities can be stand-alone, flagged, or interactive. A stand-alone activity provides user interaction, but no data resulting from the interaction is stored for future use. A flagged activity provides data indicating that the user has taken part in the activity. For an interactive activity, data resulting from the user's participation in the activity is captured and stored. Using the previously described example of a student taking a course, the data from a flagged activity indicates to an instructor whether a student has participated in the activity. The data from an interactive activity includes the user responses to elements of the activity, e.g., answers to multiple choice questions, fill in the blanks, etc. Flagged and interactive activities include a URL that the activity data is sent to. In the student/instructor example, the data from an interactive activity is graded, either by the instructor or automatically, and the grade made available to the student.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor” and “a processor”, or “the microprocessor” and “the processor,” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices that can be similar or different devices. Use of such “microprocessor” or “processor” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet. References herein to microprocessor instructions or microprocessor-executable instructions, in accordance with the above, can be understood to include programmable hardware.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, can be made by those skilled in the art. Accordingly, the spirit and scope of the present methods and systems is to be limited only by the following claims.

1. A method of presenting at least one content page of a document, comprising:
storing the document as a plurality of flash files, each flash file including a different content page of the document for presentation,
providing a flash reader file including tools for choosing content pages and displaying flash files,
receiving input to the flash reader file indicating a chosen content page from the document, and
executing the flash reader file to display a flash file corresponding to the chosen content page to present the chosen content page.

2. The method of claim 1, wherein storing the document comprises:
identifying content pages in the document to obtain identified content pages,
translating each of the identified content pages as a flash file for storage as one of the plurality of flash files,
creating a manifest of the plurality of flash files, and
identifying in the manifest each of the plurality of flash files as a being a part of the document, an order of the plurality of flash files corresponding to an order of the content pages in the document, and a storage location for each of the plurality of flash files.

3. The method of claim 2, wherein creating the manifest comprises generating an XML file, the flash reader file reading the XML file to determine the flash file corresponding to the chosen content page for display.

4. The method of claim 2, wherein translating comprises generating a key in each of the plurality of flash files to prevent displaying the flash file without executing the flash reader file.

5. The method of claim 4, wherein the key comprises password protection.

6. The method of claim 4, wherein executing the flash reader file comprises:
receiving login information, and
authorizing execution of the flash file reader based on the login information.

7. The method of claim 2, wherein translating comprises embedding, in each of the plurality of flash files, processing information including at least one of a processing date and a processing time, and embedding document information including at least one of document name, author name, chapter name, chapter number, section name and copyright information.

8. The method of claim 2, wherein the document is formatted as an XML file and wherein identifying content pages comprises defining an amount of content for a flash file, so that each identified page contains no more than the amount of content defined.

9. The method of claim 2, wherein the document is formatted as a PDF file and identifying content pages comprises corresponding the content pages with page breaks of the PDF file.

10. An interface for reading an electronically stored document, wherein the document is stored as a plurality of flash files, each flash file corresponding to a content page of the document, the interface stored on computer-readable medium and comprising instructions for controlling a processor to:
display a flash movie, the movie including tools for choosing content pages of the document and displaying flash files,
receive input through the tools indicating a chosen content page from the document, and
display a flash file corresponding to the chosen content page for reading of the chosen content page.

11. The interface of claim 10, wherein the instructions for controlling the processor to receive input further comprise instructions for controlling the processor to:
highlight at least one portion of the chosen content page to provide a highlighted portion for differentiating the highlighted portion from other portions of the display, and
associate highlighting information for the highlighted portion with the flash file corresponding to the chosen content page.

12. The interface of claim 11, wherein the instructions for controlling the processor to receive input further comprise instructions for controlling the processor to, at least one of:
delete the highlighted portion,
add a link from the highlighted portion to at least one of another portion of the chosen content page and another one of the content pages,
associate a media file with the highlighted portion,
display at least one media file associated with the highlighted portion,
associate a URL with the highlighted portion,
open a browser window and load a web page corresponding to a URL associated with the highlighted portion, and
attach a note to the highlighted portion.

13. The interface of claim 11, further comprising instructions for controlling the processor to store the highlighting information on computer-readable medium of at least one of a local processor executing the instructions for the interface and a server connected to the local processor, wherein the server transmits the flash files to the local processor for display.

14. The interface of claim 10, wherein the instructions for controlling the processor to receive input further comprise instructions for controlling the processor to:
display a text input field on the chosen content page,
receive text input into the text input field, and
display the text input in a note field on the chosen content page when the chosen content page is displayed.

15. The interface of claim 14, further comprising instructions for controlling the processor to store note field data on computer-readable medium of at least one of a local processor executing the instructions for the interface and a server connected to the local processor, wherein the server transmits the flash files to the local processor for display.

16. The interface of claim 14, further comprising instructions for controlling the processor to, at least one of:
associate the note field with the chosen content page, wherein the note field is displayed only on the chosen content page, and
associate the note field with the document, wherein the note field is displayed on each content page chosen.

17. The interface of claim 10, wherein the instructions for controlling the processor to display a flash movie further comprise instructions for controlling the processor to:
display a listing of tab functions, the listing including a search function, a bookmark function and tab functions for displaying a table of contents for the document, a glossary for the document and an index for the document,
receive input indicating a chosen tab function, and
execute the chosen tab function.

18. The interface of claim 17, wherein the instructions for controlling the processor to execute the chosen tab function when the chosen function is the search function further comprise instructions for controlling the processor to:
receive text input,
in response to the text input, display a listing of instances of the text input in the document, the listing including, for each instance, text adjacent to the text input,
receive input indicating a chosen instance, and
in response to the input indicating a chosen instance, display a flash file corresponding to a content page having the chosen instance thereon, the chosen instance being differentially displayed from other portions of the content page.

19. The interface of claim 17, wherein the instructions for controlling the processor to execute the chosen tab function when the chosen function is the bookmark function further comprise instructions for controlling the processor to:
display a listing of bookmarks,
display text associated with a bookmark when an indicator is located on the bookmark,
in response to input indicating a chosen bookmark, display a flash file corresponding to a content page associated with the chosen bookmark, and
in response to input indicating adding a new bookmark,
display a text input field,
receive text input into the text input field,
associate the text with the new bookmark, and
add the new bookmark to the listing of bookmarks.

20. The interface of claim 17, wherein the instructions for controlling the processor to execute the chosen tab function when the chosen function is the tab function for displaying the table of contents further comprise instructions for controlling the processor to:
display the table of contents for the document, and
in response to input indicating an item in the table of contents, display a flash file corresponding to a content page associated with the item.

21. The interface of claim 17, wherein the instructions for controlling the processor to execute the chosen tab function when the chosen function is the tab function for displaying the glossary further comprise instructions for controlling the processor to:
display the glossary for the document, and
in response to input indicating a term in the glossary, display a definition of the term.

22. The interface of claim 17, wherein the instructions for controlling the processor to execute the chosen tab function when the chosen function is the tab function for displaying the index further comprise instructions for controlling the processor to:
display the index for the document, the index including hierarchical listings of terms and corresponding indications of content pages associated with each of the terms, and
in response to input denoting an indication, display a flash file corresponding to a content page associated with the term that the indication corresponds with.

23. The interface of claim 10, further comprising instructions for controlling the processor to:
link to a file containing an activity associated with the chosen content page,
display the activity, and
store results of the activity in response to input denoting completion of the activity.

24. The interface of claim 23, wherein the instructions for controlling the processor to link to a file containing the activity further comprise instructions for controlling the processor to, prior to linking:
display a notice that an activity is associated with the chosen content page, and
receive input denoting acceptance of the activity.

25. A method of converting an electronic document, comprising:
identifying content pages in the document to obtain identified content pages,
translating each of the identified content pages as a flash file for storage as one of a plurality of flash files,
creating a manifest of the plurality of flash files,
identifying in the manifest each of the plurality of flash files as a being a part of the document, an order of the plurality of flash files corresponding to an order of the content pages in the document, and
identifying in the manifest a storage location for each of the plurality of flash files.
